(19) United States
(12) Patent Application Publication
(10) Pub. No.: US 2026/0091524 A1
(43) Pub. Date: Apr. 2, 2026

(54) MULTI-PURPOSE AIR DUCT TOOL

(71) Applicants: Christopher McConnell, Cooper City, FL (US); Bryce Laufenberg, Cooper City, FL (US)

(72) Inventors: Christopher McConnell, Cooper City, FL (US); Bryce Laufenberg, Cooper City, FL (US)

(21) Appl. No.: 18/900,114

(22) Filed: Sep. 27, 2024

(51) Int. Cl. B26B 1/08; F24F 13/02

(52) U.S. Cl. CPC B26B 1/08; F24F 13/0245

(57) ABSTRACT

A multi-purpose air duct tool assembly that includes main housing shaped and sized to be handheld, having a bottom wall, having a sidewall coupled to the bottom wall and enclosing and defining a housing cavity within the main housing, defining a blade opening thereon, defining a button opening thereon, and defining an upper housing opening, wherein the assembly also includes a blade member disposed within the housing cavity and operably coupled to a button disposed in the button opening and operably configured to translate the blade member through the blade opening and a squeegee retention cartridge selectively removably coupled to the main housing, disposed within the housing cavity, and retaining a squeegee member of a slender configuration with a thickness less than a transverse length of the squeegee member and projecting in an outwardly orientation away from the housing cavity and the upper housing opening.

### FIELD OF THE INVENTION

The present invention principally relates generally to tools intended for air ducts and, more particularly, relates to a handheld tool for facilitating in repairing, maintaining, and/or assessing an air duct.

### BACKGROUND OF THE INVENTION

Ducts are conduits or passages used in heating, ventilation, and air conditioning (HVAC) to deliver and remove air within or associated with a building structure. The needed airflows include, for example, supply air, return air, and exhaust air. Ducts commonly also deliver ventilation air as part of the supply air. As such, air ducts are one method of ensuring acceptable indoor air quality as well as thermal comfort. Creating a system of ductwork generally requires the installation and assembly of multiple ducts with one or more fasteners, such as tape. Air ducts are typically made with a material enabling a user to cut through said material, e.g., sheet galvanized steel, aluminum, fiberglass, polyurethane, etc., for inspection and/or repair. After the duct is accessed by the user, the user is then typically required to patch or otherwise repair said duct for conventional and effective use. Some ductwork also utilizes fasteners that are also required to be manipulated in order to access or assess one or more portions of a duct.

To that end, many users, in particular HVAC professionals, are required to carry around and/or have access to multiple tools in order to effectively and efficiently inspect, repair, install, or maintain ductwork. As most ductwork is located in tight spaces and/or elevated locations within a building structure, carrying the tools needed to effectively and efficiently inspect, repair, and/or maintain ductwork is often an arduous task. More specifically, the users are generally required to carry those tools on a belt or other similar apparatus that can be heavy and cumbersome. Additionally, having all necessary tools in close proximity to the ductwork can sometimes be impracticable or impossible.

Therefore, a need exists to overcome the problems with the prior art as discussed above.

### SUMMARY OF THE INVENTION

The invention provides a multi-purpose air duct tool that overcomes the hereinafore-mentioned disadvantages of the heretofore-known devices and methods of this general type and that facilitates in repairing, maintaining, and/or assessing an air duct.

With the foregoing and other objects in view, there is provided, in accordance with the invention, a multi-purpose air duct tool that includes a main housing shaped and sized to be handheld, having a bottom wall, having a sidewall coupled to the bottom wall and enclosing and defining a housing cavity within the main housing, defining a blade opening thereon, defining a button opening thereon, and defining an upper housing opening, a blade member disposed within the housing cavity and that is operably coupled to a button disposed in the button opening and operably configured to translate the blade member through the blade opening, and a squeegee retention cartridge selectively removably coupled to the main housing, disposed within the housing cavity, and retaining a squeegee member of a slender configuration with a thickness less than a transverse length of the squeegee member and projecting in an outwardly orientation away from the housing cavity and the upper housing opening.

In accordance with another feature, an embodiment of the present invention includes the housing wall having two opposing sides with one of the two opposing sides having the blade opening defined thereon, a front surface flanked by the two opposing sides and defining the button opening thereon, and a rear surface opposing the front surface and flanked by the two opposing sides.

In accordance with yet another feature, an embodiment of the present invention also includes the rear surface having a secondary button opening defined thereon and configured to receive the button therein that is operably configured to translate the blade member through the blade opening.

In accordance with a further feature of the present invention, the button opening and the secondary button opening are aligned and parallel with one another.

In accordance with an additional feature, an embodiment of the present invention also includes the squeegee retention cartridge having two separated sidewalls coupled together at a joint and defining a channel therein, spanning a cartridge width separating to opposing sides of the two separated sidewalls, and spanning from the joint to an upper cartridge opening with the squeegee member disposed therein.

In accordance with an exemplary feature of the present invention, the separated sidewalls of the retention cartridge are dynamically compressed when coupled to the main housing.

In accordance with a further feature, an embodiment of the present invention also includes the housing wall having two opposing and separated upper edges defining the upper housing opening and two opposing arcuate surfaces each partially defining the housing cavity and directly coupled to one of two opposing arcuate surfaces of the retention cartridge.

In accordance with an additional feature, an embodiment of the present invention also includes the retention cartridge having a first flange portion on one of the two separated sidewalls disposed over one of the two opposing arcuate surfaces of the retention cartridge and seated on one of the two opposing and separated upper edges of the housing wall and a second flange portion on another of the two separated sidewalls disposed over another of the two opposing arcuate surfaces of the retention cartridge and seated on another of the two opposing and separated upper edges of the housing wall.

In accordance with an additional feature of the present invention, at least one of the two opposing and separated edges defines a recessed notch thereon.

In accordance with another feature, an embodiment of the present invention also includes at least one of the separated sidewalls of the retention cartridge having a tool channel and with a tool member selectively removably coupled to the retention cartridge and disposed in the tool channel.

In accordance with an additional feature of the present invention, the blade member includes at least one tapered edge.

In accordance with yet another feature, an embodiment of the present invention also includes the squeegee retention cartridge having two separated sidewalls coupled together at a joint and defining a channel therein that spans a cartridge width separating opposing sides of the two separated sidewalls, wherein the two separated sidewalls define a cylindrical channel spanning the cartridge width and with a cylindrical notch formed by the squeegee member disposed therein.

In accordance with an exemplary feature, an embodiment of the present invention also includes the squeegee member having an upper edge, a lower edge opposing the upper edge of the squeegee member, tapered in thickness in one direction spanning toward the upper edge of the squeegee member, and tapered in thickness in an opposite direction spanning toward the lower edge of the squeegee member.

In accordance with another feature, an embodiment of the present invention also includes the button having a flanged portion shaped to correspond with a shape of the button opening, having a lower end, and having a magnet disposed at the lower end of the flanged portion and magnetically coupled to the blade member that is of a magnetic material.

In accordance with a further feature, an embodiment of the present invention also includes a blade cartridge defining a cartridge blade opening aligned with the blade opening, disposed within the housing cavity in an interposing relationship with the bottom wall and the squeegee retention cartridge, defining a cartridge button opening aligned with the button opening, and having a spring coupled thereto and the blade member, wherein the blade member is operably configured to dynamically translate through the cartridge blade opening and retract into the housing cavity.

In accordance with another feature, an embodiment of the present invention also includes at least one magnet disposed proximal to the bottom wall and configured to generate a magnetic field through the bottom wall to support a free standing weight of the multi-purpose air duct tool and at least one level assembly disposed proximal to the bottom wall and operably configured to display a visual perceivable indication of the angular orientation of the bottom wall relative to a reference surface.

The present invention may also include providing a multi-purpose air duct tool that includes a main housing shaped and sized to be handheld, having a bottom wall, having a sidewall coupled to the bottom wall and enclosing and defining a housing cavity within the main housing, defining a blade opening thereon, defining a button opening thereon, and defining an upper housing opening, a blade cartridge defining a cartridge blade opening aligned with the blade opening, defining a cartridge button opening aligned with the button opening, and configured to house a blade member operably coupled to a button disposed in the cartridge blade opening and the blade opening, wherein the blade member is operably configured to translate through the blade opening and the cartridge button opening, and having a squeegee retention cartridge selectively removably coupled to the main housing with the blade cartridge interposed between the squeegee retention cartridge and the bottom wall, disposed within the housing cavity, and retaining a squeegee member of a slender configuration with a thickness less than a transverse length of the squeegee member and projecting in an outwardly orientation away from the housing cavity and the upper housing opening.

In accordance with another feature, an embodiment of the present invention also includes the blade cartridge having a spring coupled thereto and a pushing wall configured to couple with the blade member, wherein the pushing wall is operably configured to dynamically translate causing the blade member to emit through the blade opening and retract into the housing cavity.

Although the invention is illustrated and described herein as embodied in a multi-purpose air duct tool, it is, nevertheless, not intended to be limited to just ducts, ductwork, or the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not necessarily drawn to scale but, where applicable, may be utilized to support a particular structural configuration or geometric relationship between components utilized in the assembly.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the squeegee member, or in the direction in which the squeegee retention cartridge is coupled and uncoupled to the main housing.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIGS. 1-2 depict top perspective side views of a multi-purpose air duct tool in accordance with one embodiment of the present invention;

FIG. 3 depicts a front perspective view of the multi-purpose air duct tool in FIG. 1;

FIGS. 4-5 depict front and rear elevational views, respectively, of the multi-purpose air duct tool in FIG. 1;

FIGS. 6-7 depict left and right side views, respectively of the multi-purpose air duct tool in FIG. 1;

FIGS. 8-9 depict bottom and top plan views, respectively, of the multi-purpose air duct tool in FIG. 1;

FIGS. 10-11 depict exploded views of the multi-purpose air duct tool in FIG. 1;

FIG. 12 depicts a perspective view of the main housing of the multi-purpose air duct tool in FIG. 1 in accordance with one embodiment of the present invention;

FIG. 13 depicts a top plan view of the main housing in FIG. 12;

FIGS. 14-17 depicts a bottom plan view and top plan views of the blade cartridge of the multi-purpose air duct tool in FIG. 1 in accordance with one embodiment of the present invention;

FIG. 18 depicts a blade member utilized with the multi-purpose air duct tool in FIG. 1 in accordance with one embodiment of the present invention;

FIG. 19 depicts a cover utilized with the blade cartridge in accordance with one embodiment of the present invention;

FIG. 20 depicts a perspective view of the squeegee retention cartridge of the multi-purpose air duct tool in FIG. 1 in accordance with one embodiment of the present invention;

FIG. 21 depicts a bottom plan view of the squeegee retention cartridge in FIG. 20;

FIG. 22 depicts an elevational side view of the squeegee retention cartridge in FIG. 20;

FIGS. 23-24 depict left and right elevational side views of the squeegee retention cartridge in FIG. 20; and

FIGS. 25-26 depict a perspective view and side elevational view, respectively, of the squeegee member of the multi-purpose air duct tool in FIG. 1 in accordance with one embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

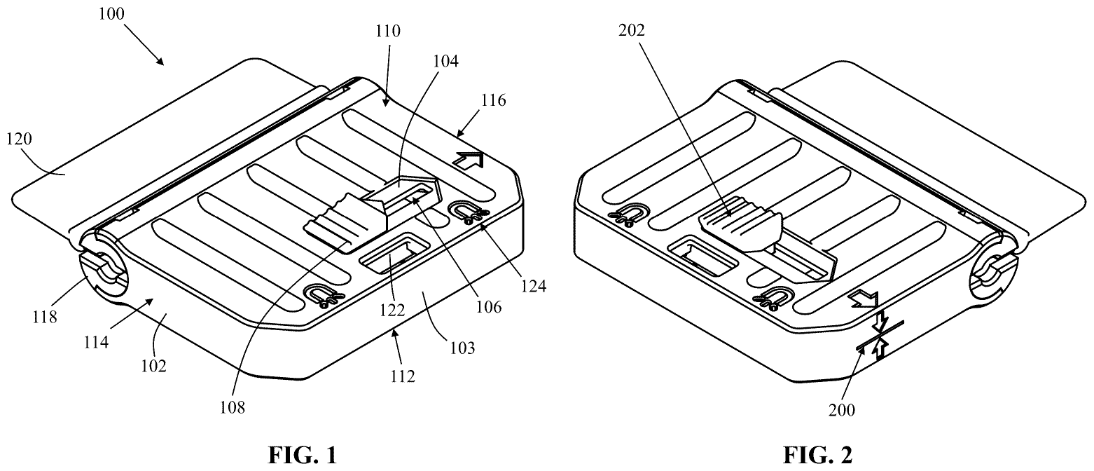

The present invention provides a novel and efficient multi-purpose air duct tool that effectively, safely, and efficiently enables use of multiple tools needed to inspect, repair, install, and/or maintain ductwork. Referring now to FIG. 1, one embodiment of the present invention is shown in a perspective view. FIG. 1, along with the other figures, shows several advantageous features of the present invention, but, as will be described below, the invention can be provided in several shapes, sizes, combinations of features and components, and varying numbers and functions of the components. The first example of an efficient multi-purpose air duct tool 100, as shown in FIG. 1, includes a main housing 102 that is preferably made of a relatively hard or rigid material with a slight degree of flexibility, e.g., a polymeric material such as polycarbonate (PC) or polyether ether ketone (PEEK). The material of the main housing 102 should also preferably be water resistant in light of its use around ductwork and air conditioning-related appliances. Beneficially and also with reference to FIGS. 1-3 and FIG. 10, the main housing 102 houses or is otherwise coupled to a blade member 300 that can extend and retract relative to the main housing 102 for cutting ductwork and other materials, a squeegee member 120 for applying pressure to HVAC tape, removing air bubbles during installation, etc., a level 122 for ensuring proper orientation of objects, and a magnetic retention assembly 124 for keeping the main housing 102 secured to magnetic structures (e.g., air-conditioning appliances, ductwork, etc.), among other uses.

More specifically, the main housing 102 is shaped and sized to be handheld, i.e., it has relative thickness, heights, and a weight that enable it to be held within a conventional user's hand without the use of any ancillary equipment. The main housing 102 includes a bottom wall 103, a sidewall 104 coupled to the bottom wall 103 and enclosing, at least partially on sides thereon, and defining a housing cavity 1000 within the main housing 102, i.e., the housing cavity 1000 is define (at least partially) by the inner surface of the main housing 102. Said differently, the term “wall” is intended broadly to encompass continuous structures, as well as, separate structures that are coupled together so as to form a substantially continuous external surface, but not necessarily along the entire height or length (depicted and exemplified best in FIG. 4 with numeral 400) of the housing 102. Said another way, the main housing 102 may include apertures (enclosed or otherwise) for components housed or attached to the housing, but still be considered enclosed because there are portions of the sidewall 104 that surround the housing cavity 1000 completely to form a wall. Further, it should be understood that terms such as, “front,” “rear,” “side,” top,” “bottom,” and the like are indicated from the reference point of a viewer viewing the device depicted in the drawings and may vary depending on the perspective.

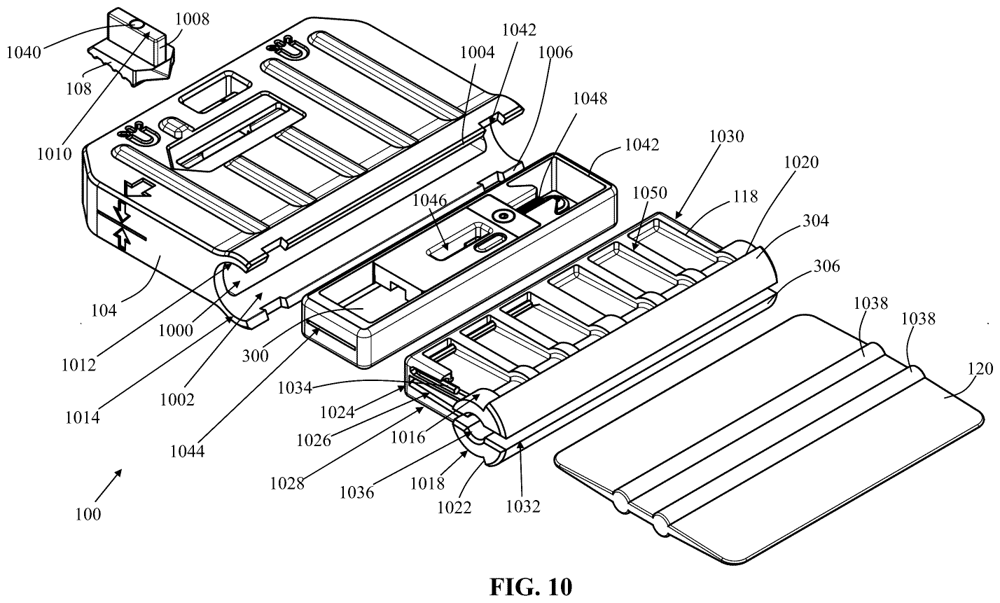

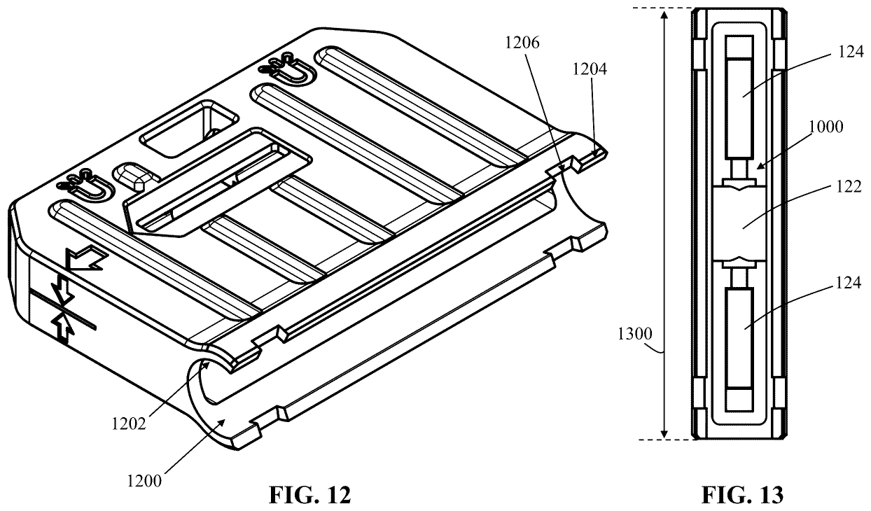

The main housing 102 can be seen defining a blade opening 200 thereon and a button opening 106 thereon, wherein each of the openings 200, 106 are preferably enclosed and elongated to minimize openings to the housing cavity 1000 and facilitate in retaining a blade member 300 and a button 108 coupled thereto and within the respective opening. The main housing 102 also defines an upper housing opening 1002 that may span continuously across a width 1300 of the housing 102 (as best depicted in FIG. 13) and is preferably defined by the upper edges 1004, 1006 of the main housing 102 that are separated and opposing one another (as best depicted in FIG. 10 and FIG. 12). In one embodiment, the width 1300 is approximately 4-6 inches and the height or length 400 is approximately 3-5 inches, e.g., providing a housing conducive to being handheld.

The assembly 100 beneficially includes a blade member 300 disposed within the housing cavity 1000, wherein the blade member 300 is operably coupled to the button 108, i.e., the button 108 is connected in some way to move the blade member 300 in the intended path of motion. The button 108 is preferably has a concave upper surface with ridges facilitating in moving the button 108 and the blade member 300 coupled thereto. The button 108 is disposed in the button opening 106, which is preferably elongated to permit effective movement, and operably configured to translate (e.g., in a linear direction) the blade member 300 through the blade opening 200. In one embodiment and as best seen in FIG. 2 and FIG. 10, the button 108 includes a flanged portion 1008 shaped to correspond with a shape of the button opening 106, includes a lower end 1010, with an opposing top end 202 defining a gripping surface, and has a magnet 1040 disposed at the lower end 1010 of the flanged portion 1008 and that is magnetically coupled to the blade member 300 that is made of a magnetic material, e.g., stainless steel. The magnet 1040 is of an opposing polarity to the blade member 300 and provides supplemental coupling, in addition to the compression of the material surrounding the blade member 300 against the flanged portion 1008, of the button 108 to the blade member 300.

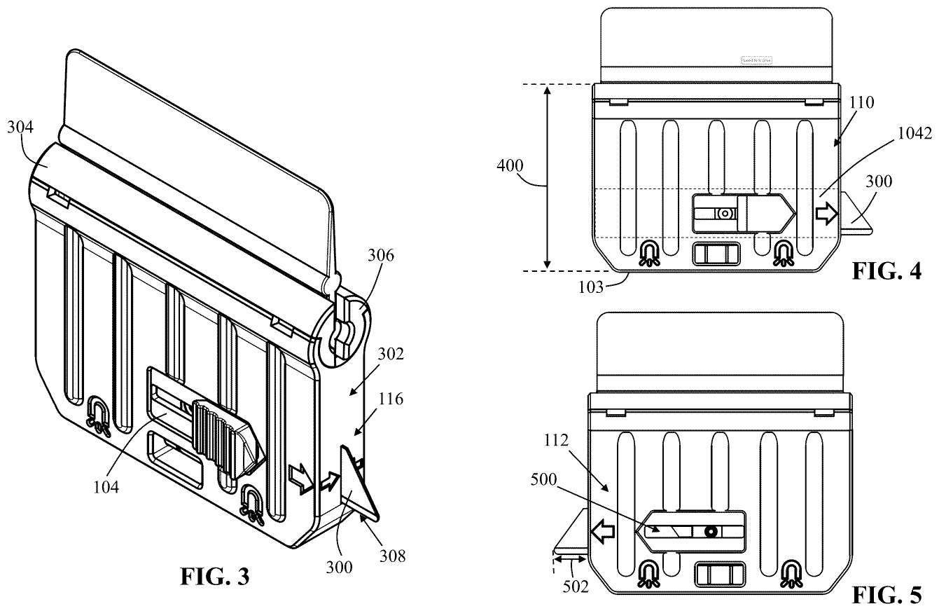

As best depicted in FIGS. 3-5, FIG. 10, and FIGS. 14-19, the blade member 300 is shown disposed in the blade opening 300 and projected outwardly a length 502 of approximately 3 inches from the outer surface 302 of a side 116 of the main housing 102. To help users remember where the blade member 300 emits from, the main housing 102 may include arrows or other indicia imprinted thereon. The blade member 300 includes at least one tapered edge 308, e.g., tapered to a sharp edge or at least tapered to a point or surface sufficient to cut aluminum or steel sheet metal used for ductwork. Beneficially, the assembly 100 may include a blade cartridge 1042, i.e., a housing body formed preferably of the same material as the main housing 102 and the squeegee retention cartridge 118. The blade cartridge 1042 defines a cartridge blade opening 1044 on a side thereof that is aligned with the blade opening 200. The blade cartridge 1042 is selectively removably disposed within the housing cavity 1000 in an interposing relationship with the bottom wall 103 and the squeegee retention cartridge 118.

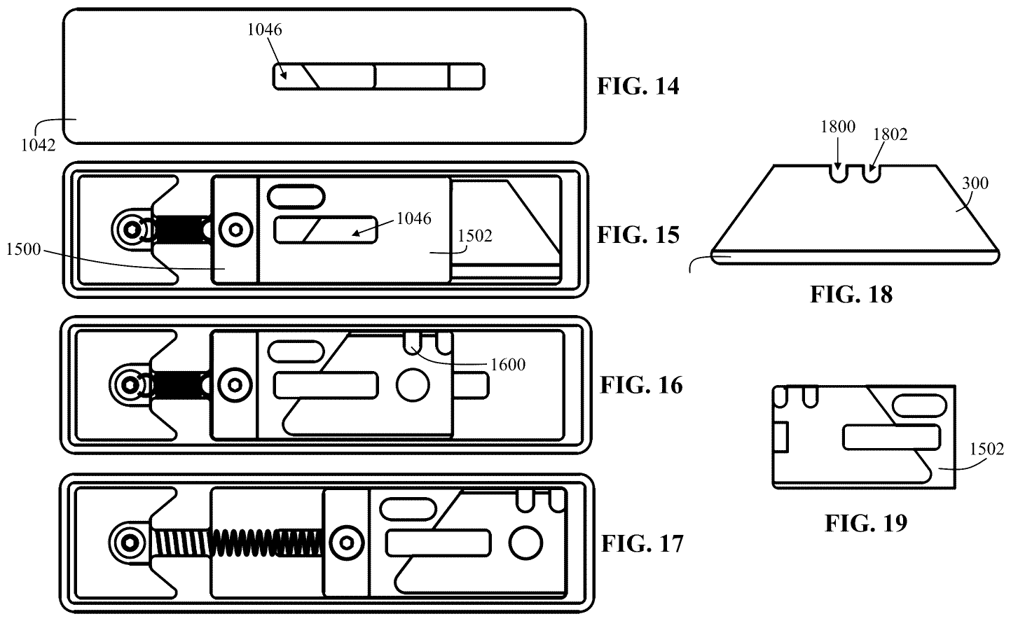

The blade cartridge 1042 defines a cartridge button opening 1046 aligned with the button opening 106 and may include a spring 1048 coupled thereto and the blade member 300. More specifically, one end of the spring 1048 may be coupled to the blade cartridge 1042 with a fastener and another end is coupled to a pushing wall 1500. The pushing wall 1500 may include portions (e.g., portion 1600) shaped to be received with conventional openings of the blade member 300, e.g., openings 1800, 1802. The pushing wall 1500 may beneficially including a retaining cover 1502 that is selectively coupled to the pushing wall 1500, wherein the retaining cover 1502 snaps into place with the pushing wall and moves with the pushing wall 1500 when desired by the user. To remove the blade member 300, the user will snap off the cover 1502. The cover 1502 may also include apertures shaped and sized to receive the button 108. The pushing wall 1500 seats the blade member 300 and ensure the cartridge blade opening 1044 is aligned with the blade opening 200. The blade member 300 preferably of a substantially rigid metallic material that is operably configured to dynamically, i.e., with an external force overcoming the spring force, translate through the cartridge blade opening 1044 and retract into the housing cavity 1000 when said external force is removed. The dynamic position of the blade member 300 and pushing wall 1502 is best depicted in FIG. 3 and FIG. 17, respectively, wherein the static position is best depicted in FIG. 2 and FIG. 16, respectively. As seen in the figures, the blade cartridge 1042 is formed with openings on both sides to enable the button 108 to be inserted into the blade cartridge 1042 from both faces or surfaces 110, 112 of the main housing 102. Beneficially, the blade cartridge 1042 is disposed proximal to the bottom wall 103 of the main housing 102, i.e., at or near, within 2 inches of the bottom wall 103.

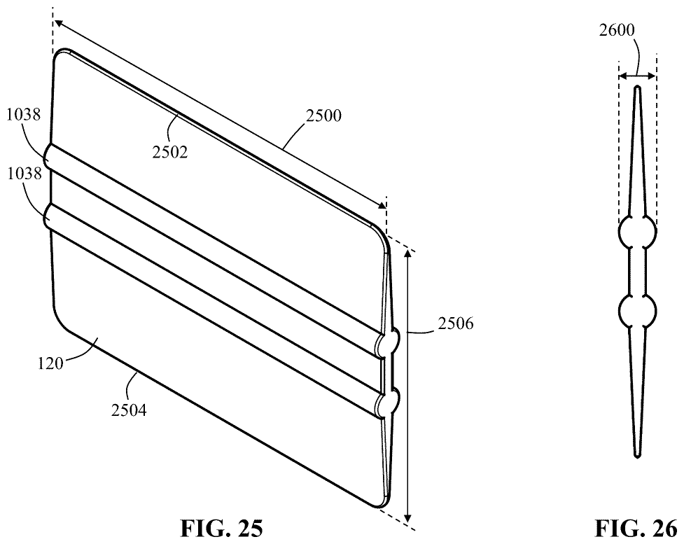

To effectively retain the squeegee member 102, the assembly 100 may utilize a squeegee retention cartridge 118 that is selectively removably coupled to the main housing 102, preferably in a snap-fit configuration without the use of fasteners so as to effectively and efficiently change the squeegee member 102 and/or access the blade member 300 and other internal components of the assembly 100. The squeegee retention cartridge 118 is also a substantially rigid body that may be made of the same or similar material as the main housing 102. The squeegee retention cartridge 118 is disposed within, at least partially, the housing cavity 1000 by inserting the squeegee retention cartridge 118 through the upper housing opening 1002 until the upper portion of the squeegee retention cartridge 118 snap fits into the main housing 102, thereby resisting removal of the squeegee retention cartridge 118. The squeegee retention cartridge 118 retains a squeegee member 120 that is designed in a slender configuration, at least partially, i.e., the squeegee member 120 has a thickness 2600 less than a transverse width 2500 of the squeegee member 120 (as best seen in FIGS. 25-26). The thickness 2600 is also preferably less than the height 2506 or length of the squeegee member 120. The max thickness 2600 may be approximately 0.25 inches, the height may be approximately 3-5 inches, and the width 2500 may be approximately equal or slightly less than the width 1300 of the main housing 102.

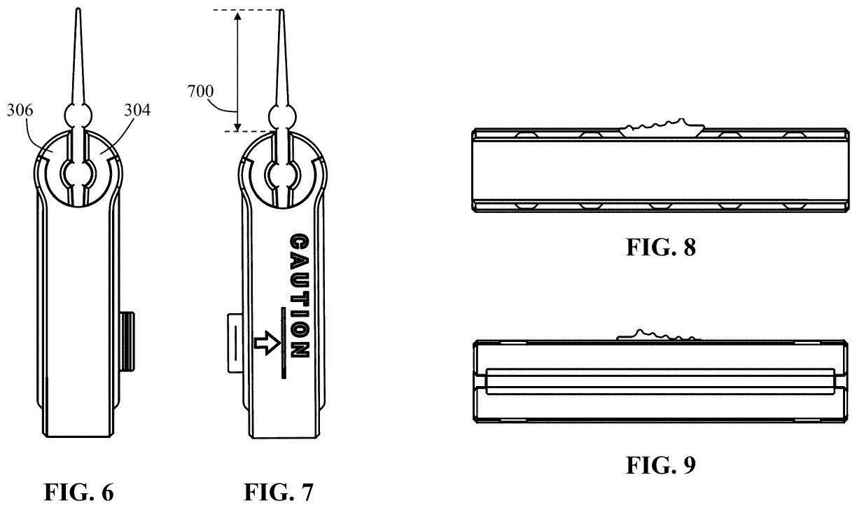

Beneficially and still with reference to FIGS. 25-26, the squeegee member 120 includes an upper edge 2502, a lower edge 2504 opposing the upper edge 2502 of the squeegee member 120, tapered in thickness 2600 in one direction spanning toward the upper edge 2502 of the squeegee member 120, and tapered in thickness 2600 in an opposite direction spanning toward the lower edge 2504 of the squeegee member 120. Said differently, the squeegee member 120 tapers, preferably uniformly, in thickness as it spans the height 2506 and in opposite directions, so as to provide a reversible squeegee member 120. To effectuate utilization of both ends of the squeegee member 120, the squeegee member 120 may be formed with two cylindrical members 1038 that span the length of the 2505, wherein the intermediate space between the two cylindrical members is a flat section disposed for receiving flat surfaces formed on both the separated sidewalls 304, 306 (as best seen in FIG. 6). Said another way, the two separated sidewalls 304, 306 of the cartridge 118 define a cylindrical channel 1036 spanning the cartridge width 2000 and have one of the cylindrical notches 1038 formed by the squeegee member 120 disposed therein. The squeegee member 120 may be symmetrically configured about a midpoint. The squeegee member 120 can be seen projecting in an outwardly orientation away from the housing cavity 1000 and the upper housing opening 1002 a length 700 (as best seen in FIG. 7) of approximately 1-2 inches. The orientation of the squeegee member 120 is parallel to the orientation of the main housing 102.

Referring back to FIGS. 1-2, the housing wall 104 can be seen having two opposing sides 114, 116 with one of the two opposing sides 114, 116 having the blade opening 200 defined thereon. In another embodiment, both sides 114, 116 may have a blade opening 200 defined thereon providing for ambidextrous handling of the main housing 102. The main housing 102 also includes a front surface 110 and a rear opposing surface 112 each flanked by the two opposing sides 114, 116. The front surface 110 and/or rear surface 112 may each define the button opening again providing for ambidextrous handling of the main housing 102 and utilizing of the blade member 300. To that end, the button 108 may be selectively removably coupled to the main housing 102 for removal and placement on either of the front or rear surfaces 110, 112 of the main housing 102. Said differently, the rear surface 112 may includes a secondary button opening 500 defined thereon and configured to receive the button 108 therein that is operably configured to translate the blade member 300 through the blade opening 200. To facilitate in providing uninhibited movement of the blade member 300 through the opening 200 and effectuating movement of the button on either face or surface of the housing 102, the button opening 106 and the secondary button opening 500 are preferably aligned and parallel with one another.

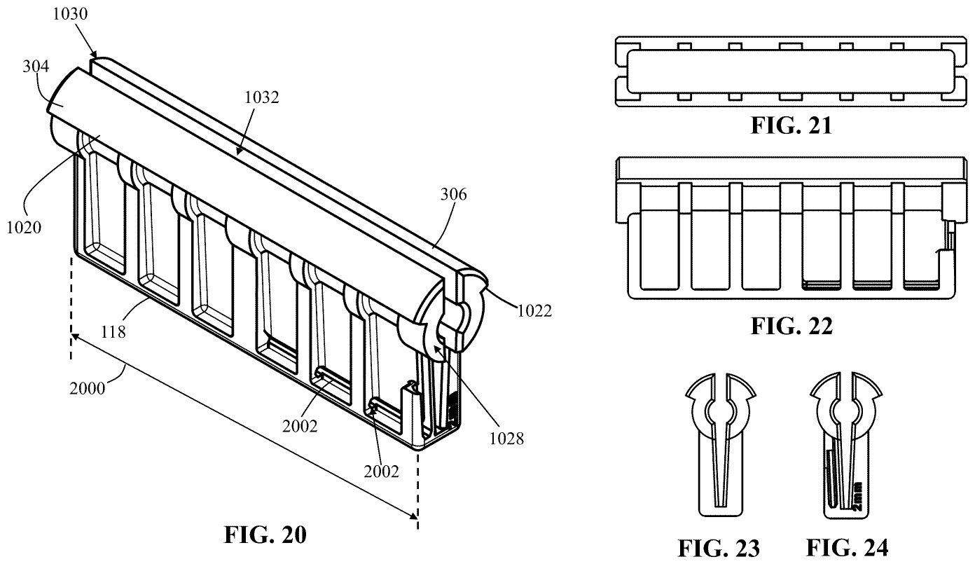

With reference to FIG. 1, FIG. 10, and FIGS. 20-24, one particular advantage and benefit of the assembly 100 is its versatility, namely having multiple tools located thereon and that are accessible and interchangeable in an efficient and effective manner. To that end, the squeegee retention cartridge 118 is configured to be easily removed and installed, yet stable enough to receive the forces conventionally applied on the squeegee member 120 without become dislodged. Specifically, the squeegee retention cartridge 118 may include two separated sidewalls 304, 306 coupled together at a joint 1024 and defining a channel 1026 therein. The joint 1024 is the connection point where the two separated sidewalls 304, 306 are directly joined together. Because of the rigidity of the material of the retention cartridge 118, the two separated sidewalls 304, 306 are operable to have a dynamic position caused by an external force with the two separated sidewalls 304, 306 flexed inwardly decreasing a spacing width of the channel 1026 and a static position (once the external force is removed or minimized) with the spacing width of the channel 1026 increased. The channel 1026 may be formed in a V-shape and the channel 1026 and joint 1024 may each span the cartridge width 2000 separating to opposing sides 1028, 1030 of the two separated sidewalls 304, 306, in addition to spanning upwardly from the joint 1024 to an upper cartridge opening 1032 that may be uniformly spaced also spanning the cartridge width 2000. The upper cartridge opening 1032 includes the squeegee member 120 disposed therein and inhibits or prevents the squeegee member 120 from be moved upwardly or downwardly. When the retention cartridge 118 is removed from the main housing 102, however, the squeegee member 120 may be removed by sliding the squeegee member 120 along the width 2000 of the retention cartridge 118.

More specifically, the separated sidewalls 304, 306 of the retention cartridge 118 are dynamically compressed when coupled to the main housing 102, i.e., the main housing 102 provides the external force to compress the two sidewalls 304, 306 together. When the separated sidewalls 304, 306 are compressed, the squeegee member 120 may slightly move side-to-side inside of the cartridge 118 but is otherwise prevented from being removed vertically out of the cartridge 118. With reference also to FIGS. 6-7, the retention cartridge 118 may also include a first flange portion 1020 formed on sidewall 304 that is disposed over an arcuate shaped surface 1016 formed on the retention cartridge 118, wherein the first flange portion 1020 is seated, preferably in a flush configuration, with an upper edge 1004 of the housing wall 104 (that opposes and is separated from another upper edge 1006 of the housing 102). The retention cartridge 118 also includes a second flange portion 1022 formed on sidewall 306 that is disposed over an arcuate shaped surface 1018 formed on the retention cartridge 118, wherein the second flange portion 1022 is seated, preferably in a flush configuration, with an upper edge 1006 of the housing wall 104. This configuration enables a structurally rigid connection between the retention cartridge 118 and the main housing 102.

To further effectuate the structurally rigid connection between the retention cartridge 118 and the main housing 102, the two opposing and separated upper edges 1004, 1006 may defining the upper housing opening 1002, wherein the housing 102 forms a cylindrical opening that is shaped and sized to receive a cylindrical shaped portion of the retention cartridge 118 and compress and secure the walls 304, 306 thereon. Said another way, the main housing 102 may include two opposing arcuate surfaces 1012, 1014 each partially defining the housing cavity 1000 and that are respectively and directly coupled to the two opposing arcuate surfaces 1016, 1018 of the retention cartridge 118 when the cartridge 118 is coupled to the main housing 102. Again, this configuration enables the external compression force inhibiting and/or preventing removal of the retention cartridge 118. As the sidewalls 304, 306 of the cartridge 118 are not completely compressed, yet still inhibit removal, the main housing 102, namely one or both of the edges 1004, 1006, may be formed with a recessed notch 1042 thereon. Preferably, there are two recessed notches 1042 formed on edge 1004 that are separated from one another and two recessed notches formed on edge 1006 that are also separated from one another. The recessed notch(es) 1042 may enable the user to insert a finger, tool, or other object under the flange portion(s) 1020, 1022 and apply a torque thereon.

In one embodiment, one or both of the separated sidewalls 304, 306 of the retention cartridge 118, namely the outer surface 1050 thereon, defines a tool channel 2002 and includes a tool member 1034 selectively removably coupled to the retention cartridge 118 and disposed in the tool channel 2002. The tool channel 2002 may have portions enclosed by the walls 304, 306 for integrity and retention and is preferably accessible from one of the sides 1028, 1030 of the walls 304, 306. Said another way, the wall(s) 304, 306 may form an opening and channel for receiving the tool, wherein the tool is hex key for driving bolts, screws, etc. or other similar tool, e.g., a screwdriver. Beneficially, the tool is recessed in the cartridge 118 so that it does not interfere with the coupling the cartridge 118 to the main housing 102.

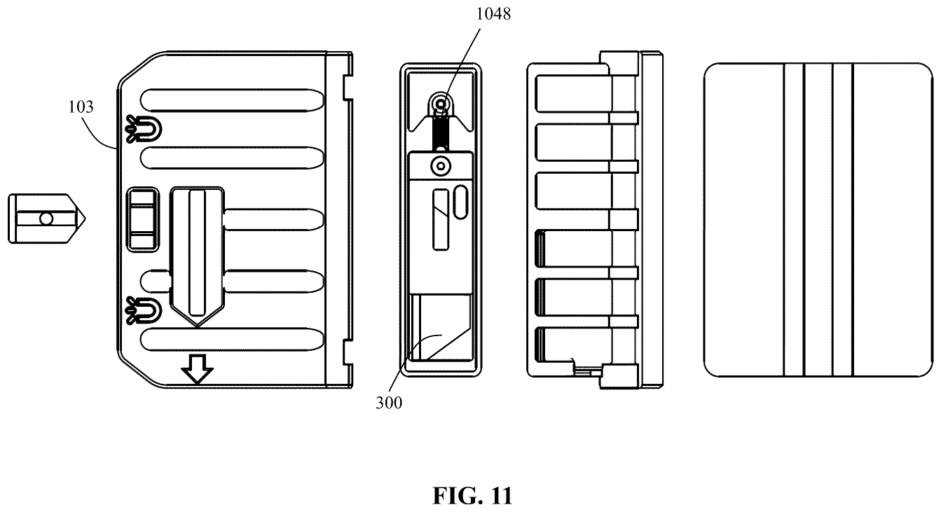

With reference to FIG. 1 and FIGS. 10-13, the tool assembly 100 may also include one or more magnets 124 disposed proximal (i.e., at or near, within 2 inches) to the bottom wall 103. The magnet(s) 124 are configured to generate a magnetic field through the bottom wall 103 to support a free standing weight of the multi-purpose air duct tool 100 (e.g., 0.05-1.0 Tesla). As such, the magnet(s) enable the tool assembly 100 to be independently supported on its side, thereby giving a user utilization versatility. To that end, the tool assembly 100 may also include one or more level assemblies, e.g., assembly 122, that is also disposed proximal to the bottom wall 103 and is operably configured to display a visual perceivable indication of the angular orientation of the bottom wall 103 relative to a reference surface, e.g., the ductwork to which it is coupled (possibly magnetically). The level assembly 122 may be laser level, a bubble or spirt level, etc. As depicted in the figures, the level assembly 122 is a bubble level that includes a vial disposed in a housing that is filled, incompletely, with a liquid, leaving a bubble in the tube. The vial has a slight upward curve, so that the bubble naturally rests in the center, at the highest point. At slight inclinations, the bubble travels away from the marked center position. The level assembly 122 is preferably centered between the magnets 124 for equal weight distribution.

Although a specific order of executing the steps of utilizing, assembling, and disassembling the air duct tool assembly have been disclosed and depicted, the order of executing the steps may be changed relative to the order shown in certain embodiments. Also, two or more steps described or depicted as occurring in succession may be executed concurrently or with partial concurrence in some embodiments. Certain steps may also be omitted for the sake of brevity. In some embodiments, some or all of the process steps can be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

What is claimed is:

1. A multi-purpose air duct tool comprising:
a main housing shaped and sized to be handheld, having a bottom wall, having a sidewall coupled to the bottom wall and enclosing and defining a housing cavity within the main housing, defining a blade opening thereon, defining a button opening thereon, and defining an upper housing opening;
a blade member disposed within the housing cavity and operably coupled to a button disposed in the button opening and operably configured to translate the blade member through the blade opening; and
a squeegee retention cartridge selectively removably coupled to the main housing, disposed within the housing cavity, and retaining a squeegee member of a slender configuration with a thickness less than a transverse length of the squeegee member and projecting in an outwardly orientation away from the housing cavity and the upper housing opening.

2. The multi-purpose air duct tool according to claim 1, wherein the housing wall further comprises:
two opposing sides with one of the two opposing sides having the blade opening defined thereon;
a front surface flanked by the two opposing sides and defining the button opening thereon; and
a rear surface opposing the front surface and flanked by the two opposing sides.

3. The multi-purpose air duct tool according to claim 2, wherein the rear surface further comprises:
a secondary button opening defined thereon and configured to receive the button therein that is operably configured to translate the blade member through the blade opening.

4. The multi-purpose air duct tool according to claim 3, wherein the button opening and the secondary button opening are aligned and parallel with one another.

5. The multi-purpose air duct tool according to claim 1, wherein the squeegee retention cartridge further comprises:
two separated sidewalls coupled together at a joint and defining a channel therein, spanning a cartridge width separating to opposing sides of the two separated sidewalls, and spanning from the joint to an upper cartridge opening with the squeegee member disposed therein.

6. The multi-purpose air duct tool according to claim 5, wherein the separated sidewalls of the retention cartridge are dynamically compressed when coupled to the main housing.

7. The multi-purpose air duct tool according to claim 6, wherein the housing wall further comprises:
two opposing and separated upper edges defining the upper housing opening; and
two opposing arcuate surfaces each partially defining the housing cavity and directly coupled to one of two opposing arcuate surfaces of the retention cartridge.

8. The multi-purpose air duct tool according to claim 7, wherein the retention cartridge further comprises:
a first flange portion on one of the two separated sidewalls disposed over one of the two opposing arcuate surfaces of the retention cartridge and seated on one of the two opposing and separated upper edges of the housing wall; and
a second flange portion on another of the two separated sidewalls disposed over another of the two opposing arcuate surfaces of the retention cartridge and seated on another of the two opposing and separated upper edges of the housing wall.

9. The multi-purpose air duct tool according to claim 8, wherein at least one of the two opposing and separated edges defines a recessed notch thereon.

10. The multi-purpose air duct tool according to claim 1, wherein at least one of the separated sidewalls of the retention cartridge further comprises:
a tool channel and with a tool member selectively removably coupled to the retention cartridge and disposed in the tool channel.

11. The multi-purpose air duct tool according to claim 1, wherein the blade member includes at least one tapered edge.

12. The multi-purpose air duct tool according to claim 1, wherein the squeegee retention cartridge further comprises:
two separated sidewalls coupled together at a joint and defining a channel therein that spans a cartridge width separating opposing sides of the two separated sidewalls, wherein the two separated sidewalls define a cylindrical channel spanning the cartridge width and with a cylindrical notch formed by the squeegee member disposed therein.

13. The multi-purpose air duct tool according to claim 1, wherein the squeegee member further comprises:
an upper edge, a lower edge opposing the upper edge of the squeegee member, tapered in thickness in one direction spanning toward the upper edge of the squeegee member, and tapered in thickness in an opposite direction spanning toward the lower edge of the squeegee member.

14. The multi-purpose air duct tool according to claim 1, wherein the button further comprises:
a flanged portion shaped to correspond with a shape of the button opening, having a lower end, and having a magnet disposed at the lower end of the flanged portion and magnetically coupled to the blade member that is of a magnetic material.

15. The multi-purpose air duct tool according to claim 1, further comprising:
a blade cartridge defining a cartridge blade opening aligned with the blade opening, disposed within the housing cavity in an interposing relationship with the bottom wall and the squeegee retention cartridge, defining a cartridge button opening aligned with the button opening, and having a spring coupled thereto and a pushing wall configured to couple with the blade member, wherein the blade member is operably configured to dynamically translate through the blade opening and retract into the housing cavity.

16. The multi-purpose air duct tool according to claim 1, further comprising:
at least one magnet disposed proximal to the bottom wall and configured to generate a magnetic field through the bottom wall to support a free standing weight of the multi-purpose air duct tool.

17. The multi-purpose air duct tool according to claim 1, further comprising:
at least one level assembly disposed proximal to the bottom wall and operably configured to display a visual perceivable indication of the angular orientation of the bottom wall relative to a reference surface.

18. A multi-purpose air duct tool comprising:
a main housing shaped and sized to be handheld, having a bottom wall, having a sidewall coupled to the bottom wall and enclosing and defining a housing cavity within the main housing, defining a blade opening thereon, defining a button opening thereon, and defining an upper housing opening;
a blade cartridge defining a cartridge blade opening aligned with the blade opening, defining a cartridge button opening aligned with the button opening, and configured to house a blade member operably coupled to a button disposed in the cartridge blade opening and the blade opening, wherein the blade member is operably configured to translate through the blade opening and the cartridge button opening; and
a squeegee retention cartridge selectively removably coupled to the main housing with the blade cartridge interposed between the squeegee retention cartridge and the bottom wall, disposed within the housing cavity, and retaining a squeegee member of a slender configuration with a thickness less than a transverse length of the squeegee member and projecting in an outwardly orientation away from the housing cavity and the upper housing opening.

19. The multi-purpose air duct tool according to claim 1, wherein the blade cartridge further comprises:
a spring coupled thereto and a pushing wall configured to couple with the blade member, wherein the pushing wall is operably configured to dynamically translate causing the blade member to emit through the blade opening and retract into the housing cavity.
